(19) United States
(12) Patent Application Publication
(10) Pub. No.: US 2006/0159085 A1
(43) Pub. Date: Jul. 20, 2006

(54) Network relay apparatus and network relay method

(75) Inventors: Joon-hee Lee, Gunpo-si (KR); In-hwan Kim, Suwon-si (KR); Dae-gyu Bae, Suwon-si (KR); Hyun-ah Sung, Seoul (KR); Jin-woo Hong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/304,891

(22) Filed: Dec. 16, 2005

(30) Foreign Application Priority Data
Jan. 14, 2005 (KR) 10-2005-0003701

(51) Int. Cl. H04L 12/56; H04L 12/28

(52) U.S. Cl. 370/389; 370/401

(57) ABSTRACT

A network relay apparatus and method are provided. The network relay includes a sub-network interface for communication with a sub-network, a plurality of backbone network interfaces for communication with a plurality of backbone networks, and a control unit for outputting data, which is received from a device included in the sub-network through the sub-network interface, through one of the backbone network interfaces. In the network relay, it is possible to fulfill various requests for communication quality by connecting the sub-network with the plurality of backbone networks.

### CROSS-REFERENCE TO RELATED APPLICATION

This application claims priority from Korean Patent Application No. 10-2005-0003701 filed on Jan. 14, 2005 in the Korean Intellectual Property Office, the disclosure of which is incorporated herein in its entirety by reference.

### BACKGROUND OF THE INVENTION

1. Field of the Invention

Apparatuses and methods consistent with the present invention relate to relaying data between a sub-network and a plurality of backbone networks.

2. Description of the Prior Art

Recently, with the spread of various kinds of local area networks (LANs) and wire/wireless Internet networks, home network systems have appeared. A home network system serves to connect various kinds of devices, such as personal computers (PCs), intelligent appliances and wireless communication devices through one network. This enables communications between the devices constituting the home network system and allows users to control various devices using one device.

Such a home network system may be provided as a set of one or more sub-networks. An example of a home network system is illustrated in FIG. 1.

The home network system 100, as illustrated in FIG. 1, includes a backbone network 110 and three sub-networks: a first sub-network 120, a second sub-network 130, and a third sub-network 140.

The backbone network 110 serves to connect the respective sub-networks 120, 130 and 140.

The respective sub-network 120, 130 or 140 includes one or more devices and network relay apparatuses 122, 132 and 142, respectively, for connecting the sub-networks 120, 130 and 140 with the backbone network 110.

Devices corresponding to one sub-network communicate with one another without such a network relay apparatus. However, devices corresponding to different sub-networks communicate with one another through a network relay apparatus.

For example, if a device 5 included in the second sub-network 130 transmits data to a destination device 1 included in the first sub-network 120, the data transmitted from the device 5 is received by the network relay apparatus 132 included in the second sub-network 130. At this time, the network relay apparatus 132 identifies a destination address of the data transmitted from the device 5 and outputs the data to the backbone network 110.

The network relay apparatus 122 included in the first sub-network 120 identifies that the data transmitted through the backbone network 110 is destined for the device 1, and outputs the data to the device 1.

In other words, the network relay apparatus serves to either output the data transmitted from its sub-network to the backbone network or to input the data transmitted from the backbone network to the sub-network.

The sub-network may be divided depending on the structure of a home or an installation state of a cable. For example, the first sub-network 120 shown in FIG. 1 may correspond to a living room, the second sub-network 130 may correspond to a bedroom, and the third sub-network 140 may correspond to a kitchen.

Furthermore, the sub-network may be divided depending on the purpose for the devices. For example, the first sub-network 120 may be a group of devices for home control and management, the second sub-network 130 may be a group of devices for audio and/or visual (AV) streaming services, and the third sub-network 140 may be a group of PC-related devices.

As described above, since various kinds of sub-networks may exist, various kinds of optimal backbone networks may be provided for communication with devices included in another sub-networks. For example, a backbone network that supports a high data transmission rate may be required between devices that provide AV streaming services. A backbone network that supports a high quality of service (QoS) may be required between devices that provide voice communication services. On the other hand, a backbone network that supports a relatively low data transmission rate and a low QoS may be used between devices for home control and management.

In the case where various requests for different communication quality exist, it is preferable that a backbone network that ensures communication quality suitable for the respective communication can satisfy these requirements based on various kinds of backbone networks is be used.

However, since the related art network relay apparatus supports a network relay using only one backbone network, it is impossible to fulfill various requests for different communication quality.

Meanwhile, Korean Registered Patent No. 10-260035 discloses an interface device of a communication system that provides audio data and broadband data services; the communication system includes four interfaces for accessing an asynchronous transfer mode (ATM) network, a LAN, a private branch exchange (PBX), and a set top box (STB), and a controller for switching the audio, data, and video transmitted to and received from the respective interfaces and providing them to the four interfaces. However, Korean Registered Patent No. 10-260035 simply discloses a device that exchanges audio, data and video between the four interfaces, and it fails to satisfy the various communication quality requirements of the different sub-networks.

### SUMMARY OF THE INVENTION

The present invention provides a network relay apparatus and a network relay method, which can relay information between a sub-network and a plurality of backbone networks.

According to an aspect of the present invention, there is provided a network relay apparatus comprising a sub-network interface for communication with a sub-network, a plurality of backbone network interfaces for communication with a plurality of backbone networks, and a control unit for outputting data, which is received from a device included in the sub-network through the sub-network interface, through one of the backbone network interfaces.

According to another aspect of the present invention, there is provided a network relay method comprising receiving data from a device constituting a sub-network, and outputting the data through one of a plurality of backbone network interfaces.

### BRIEF DESCRIPTION OF THE DRAWINGS

The above and other aspects of the present invention will become more apparent from the following detailed description of exemplary embodiments of the present invention taken in conjunction with the accompanying drawings, in which:

FIG. 1 is a view illustrating a related art home network system;

FIG. 2 is a view illustrating a network system according to an exemplary embodiment of the present invention;

FIG. 3 is a block diagram illustrating the construction of a network relay apparatus according to an exemplary embodiment of the present invention;

FIG. 4 is a table illustrating the communication quality of backbone network interfaces according to an exemplary embodiment of the present invention;

FIG. 5 is a flowchart illustrating a network relay method according to an exemplary embodiment of the present invention; and

FIG. 6 is a flowchart illustrating a process of determining a processing order according to an exemplary embodiment of the present invention.

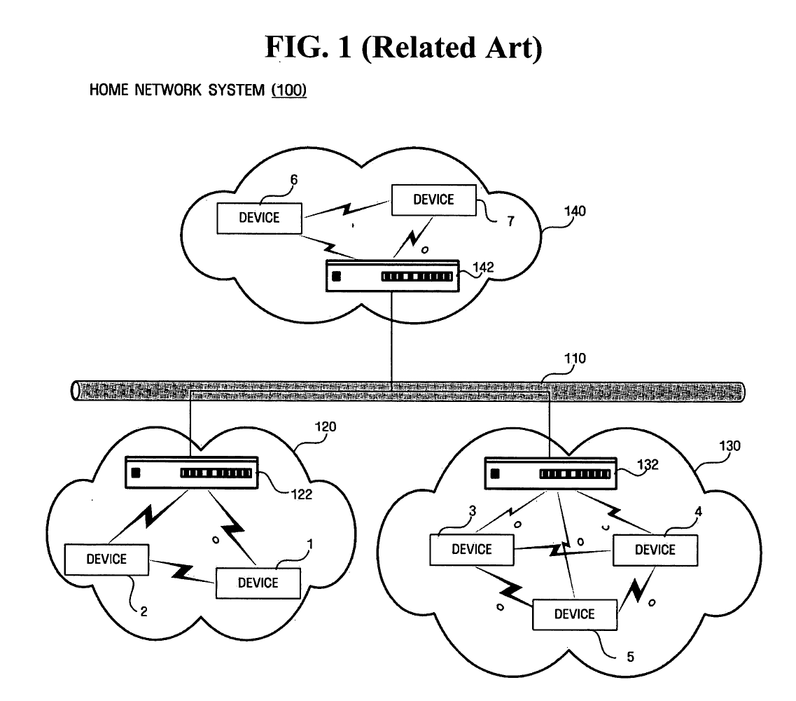

### DETAILED DESCRIPTION OF EXEMPLARY EMBODIMENTS OF THE PRESENT INVENTION

Hereinafter, preferred embodiments of the present invention will be described in detail with reference to the accompanying drawings. The aspects and features of the present invention and methods for achieving the aspects and features will be apparent by referring to the exemplary embodiments to be described in detail with reference to the accompanying drawings. However, the present invention is not limited to the exemplary embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the whole description of the present invention, the same drawing reference numerals are used for the same elements across various figures.

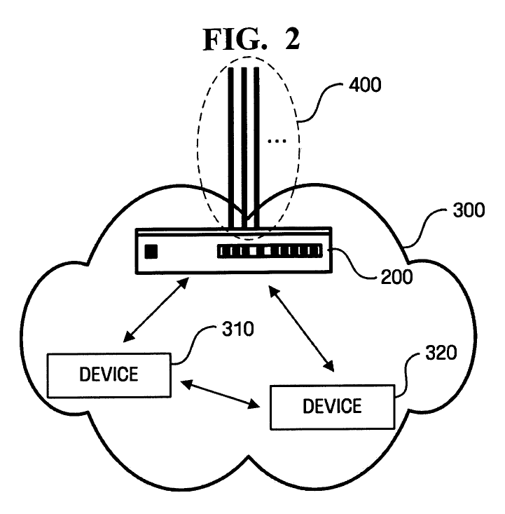

FIG. 2 is a view illustrating a network system according to an exemplary embodiment of the present invention.

As shown in FIG. 2, a device 310 and a device 320 constitute one sub-network 300 that performs communication with another sub-network (not shown) through a plurality of backbone networks 400.

A network relay apparatus 200 according to an exemplary embodiment of the present invention connects the sub-network 300 with the plurality of backbone networks 400. A router, a bridge, or an access point may be used as the network relay apparatus 200. However, the network relay apparatus 200 of the present invention is not limited to the above cases. Another device that serves to output data transmitted from the sub-network 300 to the plurality of backbone networks 400 and vice versa may be used as the network relay apparatus 200.

The sub-network 300 may be a wire network, e.g. Ethernet, IEEE 1394, Power Line Communication (PLC), or other wire network known in the art, or a wireless network, e.g Infrared Data Association (IRDA) or Ultra Wide Band (UWB), or other wireless network known in the art.

Also, the plurality of backbone networks 400 may be a wire network such as Ethernet, IEEE 1394, PLC or other wire network known in the art, or a wireless network such as IRDA or UWB, or other wireless network known in the art. It is preferable, but not necessary, that the plurality of backbone networks 400 are of different types. Therefore, the network relay apparatus 200 may include a plurality of backbone network interfaces suitable for the respective backbone networks 400 to communicate with each other.

Meanwhile, the device 310 and the device 320 may transmit a communication quality condition that should be supported by a backbone network for data transmission before transmitting the data destined for a device included in another sub-network. The network relay apparatus 200 can select a backbone network that supports the communication quality requested by the device through the communication quality condition, and can transmit the data through the selected backbone network.

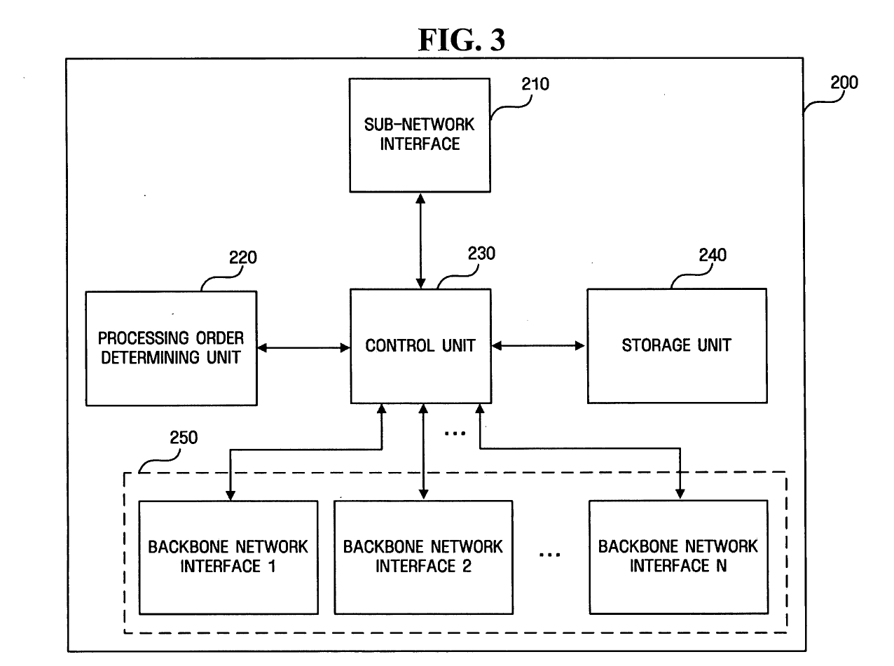

Hereinafter, the network relay apparatus 200 will be described in more detail with reference to FIG. 3.

FIG. 3 is a view illustrating the network relay apparatus 200 according to an exemplary embodiment of the present invention.

The network relay apparatus 200 shown in FIG. 3 includes a sub-network interface 210, a processing order determining unit 220, a control unit 230, a storage unit 240, and a plurality of backbone network interfaces 250.

The sub-network interface 210 performs communication with the sub-network 300. In more detail, the sub-network interface 210 receives data transmitted from the device 310 or 320 constituting the sub-network 300, or transmits data to the device 310 or 320. The sub-network interface 210 may use either a wire medium such as a coaxial cable, an optical cable, a power line or a telephone line, or other wire medium known in the art, or a wireless medium such as IR or RF or other wireless medium known in the art, as a data transmission medium. The sub-network interface 210 may be either a wire network, such as an Ethernet, IEEE 1394, PLC network, or other wireless network known in the art, or a wireless network such as an IRDA or UWB network, or other wireless network known in the art, depending on the type of data transmission medium.

The processing order determining unit 220 determines the processing order of data received through the sub-network interface 210. This processing order may be useful for ensuring the QoS of respective data. For example, data for AV streaming or voice communication data may be processed prior to other data. By contrast, data that is simply copied from one device to another may be processed later than other data.

The processing order determining unit 220 can use information of a priority field of a Media Access Control (MAC) header as a basis for determining the processing order of data. In more detail, the priority field may be a field suggested by IEEE 802.1p, but it is not limited to this. The processing order determining unit 220 may use information set in a type of service (ToS) field of an Internet Protocol (IP) header, a source of a Transmission Control Protocol (TCP) header, or a destination port number of the TCP header as the basis for determining the data processing order. Also, more complicated methods such as DiffServ and MultiProtocol Label Switching (MPLS) may be used for processing of the processing order determining unit 220.

Information used as the basis for determining the processing order of data can be determined depending on the type of the network relay apparatus 200. For example, if a wire or wireless bridge is used as the network relay apparatus 200, the information of the priority field of the MAC header can be used as the basis for determining the data processing order. However, if a router is used as the network relay apparatus 200, the information set in the ToS field of the IP header can be used as the basis for determining the data processing order.

The control unit 230 outputs the data, which is received from the device 310 or 320 included in the sub-network 300 through the sub-network interface 210, through one of the backbone network interfaces 240.

To output the data received by the sub-network interface 210 to a plurality of backbone networks 400, the control unit 230 uses a communication quality condition to determine which one of the backbone network interfaces 250 to use. The communication quality condition includes information on the communication quality provided by the backbone network interface for outputting data. The information on communication quality may include the bandwidth required for data transmission, allowable jitter, required QoS, signal to noise ratio (SNR), and channel status, or other information on communication quality known in the art. One example of the communication quality condition is shown in Table 1.

TABLE 1
An Example of Communication Quality

| Bandwidth | Jitter | SNR | QoS | . . . |
|---|---|---|---|---|
| A Mbps or greater | B ms or less | D dB or greater | High | . . . |

The communication quality condition can be acquired from the device that transmits data to be output through the plurality of backbone networks 400. Preferably, but not necessarily, the communication quality condition required to output data can be acquired before receiving data to be output through the plurality of backbone networks 400. Therefore, the devices 310 and 320 can set a communication quality condition that is suitable for transmitting data before transmitting the data to be output through the plurality of backbone networks 400, and transmit the communication quality condition to the network relay apparatus 200, but the present invention is not limited to this. The communication quality condition may be transmitted to the network relay apparatus 200 along with data to be outputted through the backbone network interface.

The control unit 230 selects one or more backbone network interfaces, which can fulfill the communication quality condition received from the device, among the plurality of backbone network interfaces 250. The control unit 230 outputs the data through one of the selected backbone network interfaces.

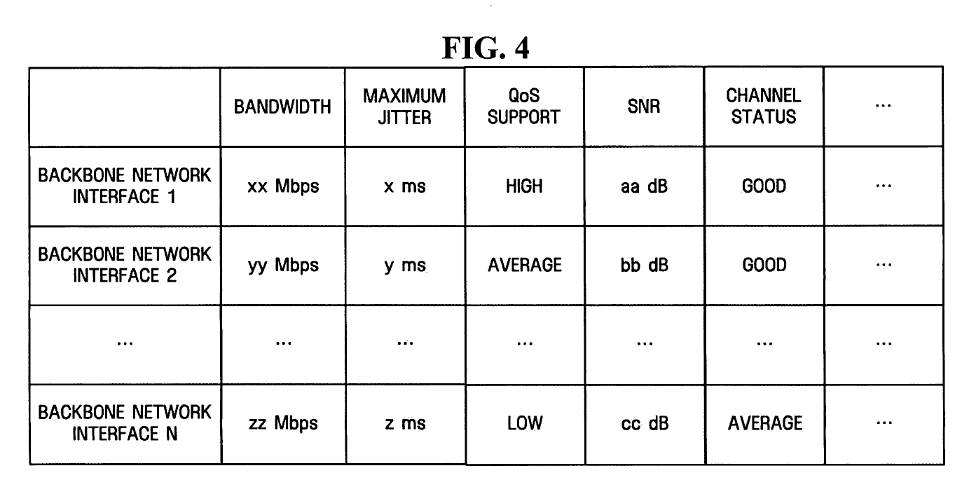

The information on the communication quality is provided by each backbone network interface and used to select the backbone network interfaces that can fulfill the communication quality condition may be stored in the storage unit 240. One example of the information is shown in FIG. 4. As shown in FIG. 4, the information on the supported communication quality of the backbone network interfaces can include bandwidth, jitter, QoS, SNR, and channel status. However, the kinds of information shown in FIG. 4 are exemplary, and the information on the communication quality of the backbone network interfaces is not limited to the information of FIG. 4. Information showing other kinds of communication quality that can be supported by the backbone network interfaces may be included in the information on the communication quality.

The control unit 230 outputs data through the backbone network interface that best fulfills the communication quality condition. However, if the backbone network interface that best fulfills the communication quality condition is being used to output other data, the control unit 230 can output the data through the another backbone network interface that satisfies the communication quality condition.

Furthermore, the control unit 230 outputs the data to the backbone network interface depending on the processing order determined by the processing order determining unit 220. In this case, the control unit 230 outputs the data through the backbone network interface in the order from the highest processing order to the lowest processing order. The control unit 230 may store data in the storage unit 240 on standby through the backbone network interface due to its lower processing order.

The plurality of backbone network interfaces 250 performs communication with the plurality of backbone networks 400. In more detail, each backbone network interface 250 receives the data transmitted through one of the plurality of backbone networks 400, or transmits the data to one of the plurality of backbone networks 400.

Each of the backbone network interfaces may use either a wire medium such as a coaxial cable, an optical cable, a power line or a telephone line or other wire medium known in the art, or a wireless medium such as IR or RF or other wireless medium known in the art, as the data transmission medium. Each of the backbone network interfaces may be either a wire network, such as an Ethernet, IEEE 1394, or PLC network or other wire network known in the art, or a wireless network such as an IRDA or UWB network or other wireless network known in the art, depending on the type of data transmission medium. The backbone network interfaces may all be different.

The plurality of backbone networks 400 comprises a plurality of medium types which may be a wire medium such as a coaxial cable, an optical cable, a power line or a telephone line or other wire medium known in the art, or a wireless medium such as IR or RF or other wireless medium known in the art, as a data transmission medium.

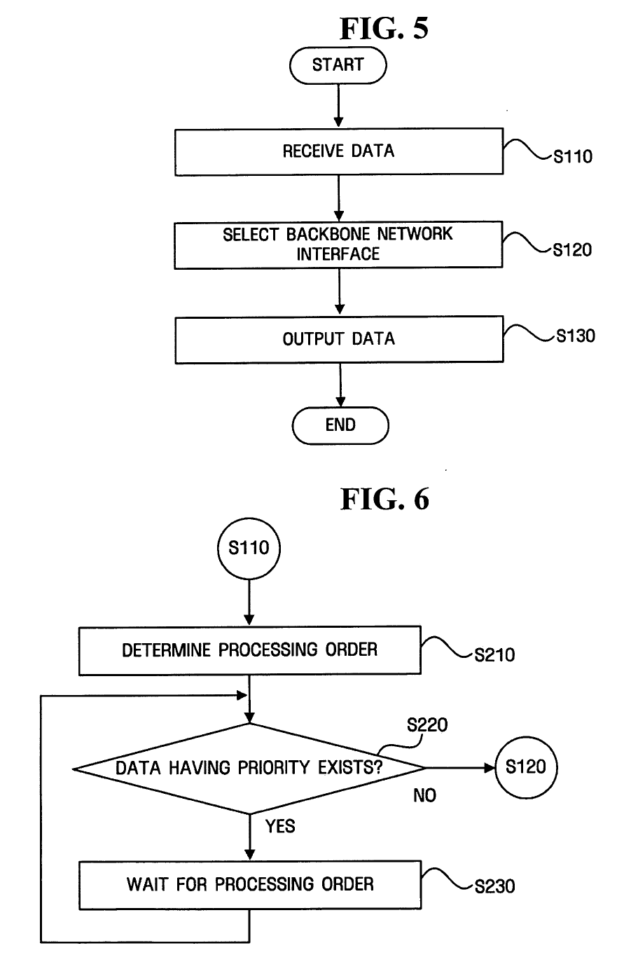

Hereinafter, the operation of respective functional blocks of the network relay apparatus 200 will be described with reference to FIG. 5.

FIG. 5 is a flowchart illustrating a network relay method according to an exemplary embodiment of the present invention.

The sub-network interface 210 receives data from a device within the sub-network 300 in operation S110, and the control unit 230 selects the backbone network interface for outputting the received data from the backbone network interfaces 250 in operation S120.

To determine which of the backbone network interfaces 240 the data is outputted through, the control unit 230 can use a communication quality condition. The communication quality condition includes information on the communication quality required to transmit the data. The information on communication quality may include the bandwidth required for data transmission, the allowable jitter, the required QoS, SNR, channel status, or other communication quality information known in the art.

The communication quality condition is preferably acquired from the device that will transmit data to be output to the plurality of backbone networks 400 before the data is output to the plurality of backbone networks 400 in operation S110, but the present invention is not limited to this. The communication quality condition may be transmitted to the network relay along with data to be outputted through the backbone network interface.

The control unit 230 selects backbone network interfaces that can fulfill the communication quality condition received from the device and determines one of the selected backbone interfaces to output the data.

The control unit 230 selects the backbone network interface that best fulfills the communication quality condition for outputting the data. However, if the backbone network interface that best fulfills the communication quality condition is being used to output other data, the control unit 230 may select another backbone network interface that most closely satisfies the communication quality condition.

The backbone network interface selected by the control unit 230 outputs the data received by the sub-network interface 210 to the backbone network in operation S130.

After receiving the data from a device of the sub-network 300, the process of determining the processing order of the received data may be additionally provided as shown in FIG. 6.

FIG. 6 is a flowchart illustrating a process of determining the data processing order according to an exemplary embodiment of the present invention.

The sub-network interface 210 receives data from the sub-network 300 in operation S110, and the processing order determining unit 220 determines the processing order of the received data in operation S210.

The processing order determining unit 220 can use the information of the priority field of the MAC header as the basis for determining the processing order of data. In more detail, the priority field may be the field suggested by IEEE 802.1p, but the priority field is not limited to such a field. The processing order determining unit 220 may use the information set in the ToS field of the IP header, the source of the TCP header, or the destination port number as the basis for determining the processing order of data. Also, more complicated methods such as DiffServ and MPLS may be used for processing of the processing order determining unit 220.

Information used as the basis for determining the processing order of data can be determined depending on the type of network relay. For example, if a wire/wireless bridge is used as the network relay, the information of the priority field of the MAC header can be used as the basis for determining the processing order of data. However, if a router is used as the network relay, the information set in the ToS field of the IP header can be used as the basis for determining the processing order of data.

If data having priority over the received data exists in operation S220, the control unit 230 puts the received data on standby in operation S230. At this time, the control unit 230 may store data in the storage unit 240 on standby due to its lower processing order.

Therefore, in an exemplary embodiment of the present invention, the control unit 230 outputs the data through the backbone network interface depending on the processing order determined by the processing order determining unit 220 in the order from the highest processing order to the lowest processing order.

As described above, the network relay apparatus and the network relay method make it possible to fulfill various requests for communication quality by connecting the sub-network with a plurality of backbone networks.

Although certain exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A network relay apparatus comprising:
a sub-network interface which communicates with a sub-network;
a plurality of backbone network interfaces which communicate with a plurality of backbone networks; and
a control unit which outputs data, which is received from a device included in the sub-network through the sub-network interface, through one of the plurality of backbone network interfaces.

2. The network relay apparatus as claimed in claim 1, wherein the plurality of backbone network interfaces are all different.

3. The network relay apparatus as claimed in claim 1, wherein each of the plurality of backbone network interfaces uses at least one data transmission medium.

4. The network relay apparatus as claimed in claim 3, wherein the at least one data transmission medium is at least one of a coaxial cable, an optical cable, a power line, a telephone line, infrared (IR), or radio frequency (RF).

5. The network relay apparatus as claimed in claim 1, wherein the backbone network interface that outputs the data satisfies a communication quality condition for outputting the data.

6. The network relay as claimed in claim 5, wherein the communication quality condition is received from the device.

7. The network relay as claimed in claim 5, wherein the communication quality condition includes at least one of a bandwidth, a jitter, a quality of service, a signal to noise ration, and a channel status.

8. The network relay as claimed in claim 1, further comprising a processing order determining unit that determines a processing order of the data that the control unit uses to output the data.

9. The network relay as claimed in claim 8, wherein the processing order is determined depending on one of priority field information of a Media Access Control header, type of service field information of an internet protocol header, a source of a transmission control protocol header, and a destination port number.

10. A network relay method comprising:
receiving data from a device included in a sub-network; and
outputting the data through one of a plurality of backbone network interfaces.

11. The network relay method as claimed in claim 10, wherein the plurality of backbone network interfaces are all different.

12. The network relay method as claimed in claim 10, wherein each of the plurality of backbone network interfaces uses at least one data transmission medium.

13. The network relay method as claimed in claim 12, wherein the at least one data transmission medium is at least one of a coaxial cable, an optical cable, a power line, a telephone line, infrared (IR), or radio frequency (RF).

14. The network relay method as claimed in claim 10, wherein the backbone network interface that outputs the data satisfies a communication quality condition for outputting the data.

15. The network relay method as claimed in claim 14, wherein the communication quality condition is received from the device.

16. The network relay method as claimed in claim 14, wherein the communication quality condition includes at least one of a bandwidth, a jitter, a quality of service, a signal to noise ratio, and a channel status.

17. The network relay method as claimed in claim 10, further comprising determining a processing order that is used to output the data.

18. The network relay method as claimed in claim 17, wherein the processing order is determined depending on one of priority field information of a Media Access Control header, type of service field information of an internet protocol header, a source of a transmission control protocol header, and a destination port number.
